(19) United States
(12) Patent Application Publication
(10) Pub. No.: US 2004/0153625 A1
(43) Pub. Date: Aug. 5, 2004

(54) Array-type processor

(75) Inventors: Taro Fujii, Kawasaki (JP); Koichiro Furuta, Kawasaki (JP); Masato Motomura, Kawasaki (JP); Kenichiro Anjo, Kawasaki (JP); Yoshikazu Yabe, Kawasaki (JP); Toru Awashima, Kawasaki (JP); Takao Toi, Kawasaki (JP); Noritsugu Nakamura, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 10/761,365

(22) Filed: Jan. 22, 2004

(30) Foreign Application Priority Data
Jan. 27, 2003 (JP) 2003-017820

(51) Int. Cl. G06F 15/00

(52) U.S. Cl. 712/13

(57) ABSTRACT

In an array-type processor in which a multiplicity of processor elements, which each execute data processing in accordance with instruction codes in which data are individually set, are arranged in rows and columns, and in which state control units cause successive transitions of the operating states of this multiplicity of processor elements for each operating cycle by means of contexts that are make up by instruction codes, a plurality of element areas are respectively connected to an equal number of state control units, and state control units that correspond to a prescribed number of operating states that are set to one context temporarily halt the operation of element areas to which the state control unit is connected during operating cycle in which operating states do not occur.

### BACKGROUND OF THE INVENTION

1. Field of the Invention

The present invention relates to an array-type processor in which a multiplicity of processor elements that each individually executes data processing and for which the connection relations between the processor elements is switch-controlled are arranged in rows and columns and in which the operations of this multiplicity of processor elements are controlled by a state control unit.

2. Description of the Related Art

Products referred to as CPUs (Central Processing Units) and MPUs (Micro Processor Units) are currently in practical use as processor units that can freely execute various types of data processing.

In data processing systems that employ these processor units, various application programs that are described by a plurality of instruction codes and various types of processing data are stored in memory devices, the processor units read these instruction codes and processing data in order from the memory devices and successively execute a plurality of operations.

A single processor unit can therefore execute various types of data processing, but in this data processing, the plurality of operations must be successively executed in order and the processor unit must read the instruction codes from the memory device for each successive process, and it is therefore difficult to execute complex data processing at high speed.

On the other hand, when the data processing that is to be executed is limited to a single type, constructing logic circuits to execute this data processing by hardware eliminates the need for a processor unit to read a plurality of instruction codes from memory devices in order and then successively execute the plurality of operations in order. Thus, although complex data processing can be executed at high speed, obviously, only a single type of data processing can be executed.

In other words, a data processing system that allows free switching of application programs enables the execution of various type of data processing, but the execution of high-speed data processing is problematic because the configuration of the hardware is fixed. On the other hand, logic circuits that are constituted by hardware enable high-speed execution of data processing but can execute only one type of data processing because they do not permit modification of the application program.

With the aim of solving this problem, the present applicant has invented and submitted an application for an array-type processor as a data processing device in which the hardware configuration changes in accordance with software. In this array-type processor, a multiplicity of small-scale processor elements are arranged in rows and columns together with a multiplicity of switch elements in a datapath unit, one state control unit being provided together with one of these data path units. The multiplicity of processor elements each individually execute data processing in accordance with instruction codes in which data are individually set, and switching of connection relations is controlled by a multiplicity of switch elements that are individually provided together with the processor elements.

The array-type processor can therefore execute various types of data processing in accordance with software because the configuration of the data paths is changed by switching the instruction codes of the multiplicity of processor elements and the multiplicity of switch elements, and can execute data processing at high speed because, as hardware, a multiplicity of small-scale processor elements simultaneously execute simple data processing.

The array-type processor can continuously execute simultaneous processing in accordance with a computer program because the context of the datapath unit, which is made up of the instruction codes of the above-described multiplicity of processor elements and multiplicity of switch elements, is successively switched by a state control unit for each operation cycle in accordance with the computer program and event data.

In the above-described array-type processor, a plurality of stages of operating states, which undergo successive transitions under the control of a state control unit, have a one-to-one correspondence with contexts, which are successively switched by a data path unit for each operating cycle. However, as submitted by the present applicant in Japanese Patent Application No. 304222 (2002), it is also possible for a plurality of operating states to be set to a single context.

For example, as a result of scheduling a plurality of operating states, operating states are generated in which few processor elements are assigned, as shown in FIG. 1A. When a plurality of operating states that are generated by data are assigned to a plurality of contexts on a one-to-one basis in this way, one particular context generates of a state that brings about the operation of only one portion of processor elements that are arrayed in an array-type processor.

However, as shown in FIG. 1B, the successive integration of the number of assigned processor elements in a plurality of continuous operating states and a transition of contexts each time this integrated number exceeds a prescribed permissible number allows the greatest possible number of processor elements to be set to each of a plurality of contexts.

For example, when the first to third operating states are set to a first context and fifth and sixth operating states are set to the third context in an array-type processor that operates in accordance with the object program, the data processing of the first operating state of the first context is executed in the first operating cycle, the data processing of the second operating state of the first context is executed in the second operating cycle, and the data processing of the third operating state of the first context is executed in the third operating cycle, as shown in FIG. 2.

In the fourth operating cycle, the first context is switched to the second context and the data processing of the fourth operating state is executed, and in the fifth operating cycle, the second context is switched to the third context and the data processing of the fifth operating state is executed.

When a plurality of operating states are set to a single context as described above, the required time for data processing in an array-type processor is the same as for a case in which one operating state is set to one context, but since the number of contexts that are data-set in a computer program is reduced, the volume of data of a computer program can be decreased. Further, the decrease in the number of times that the state control unit switches the contexts of the data path unit also enables a reduction of power consumption.

Although an example was described in the foregoing explanation in which two continuous operating states were set to a single context, more than two operating states may be set, or as shown in FIG. 3 and FIG. 4, a plurality of discontinuous operating states may also be set. In such a case, the number of times that the state control unit switches the contexts of the data path unit cannot be reduced in some cases, but the number of contexts that are data-set in the computer program can be reduced.

Array-type processors according to the preceding explanation have been proposed by the present applicant (as an example, refer to the Japanese Patent Laid-Open Publication No. 312481/2001).

In actuality, however, even when operating states of a plurality of stages are simply set to a single context in an array-type processor of the above-described type, the operating states of the plurality of stages occur simultaneously in the operating cycles of that context.

### SUMMARY OF THE INVENTION

The present invention was developed in view of the above-described problems and has as an object the provision of an array-type processor that functions effectively even when a plurality of operating states are set to one context.

In the array-type processor of the present invention, a multiplicity of processor elements, which individually execute data processing in accordance with instruction codes in which data are individually set, are arranged in rows and columns; and a state control unit causes successive transitions of the operating states of this multiplicity of processor elements for each operating cycle by means of contexts that are composed of instruction codes.

In the first invention in the above-described array-type processor, a multiplicity of processor elements are divided into a plurality of element areas; one state control unit is connected to this plurality of element areas; a prescribed number of operating states that occur in different operating cycles are set to at least one portion of contexts; and the state control unit temporarily halts the operation of element areas that correspond to a prescribed number of operating states that are set to one context during operating cycles in which operating states do not occur.

In the second invention, each of a plurality of element areas is connected to a respective state control unit of an equal number of element areas, and state control units temporarily halt operations of the element areas to which the state control units are connected, the operations of the element areas corresponding to a prescribed number of the operating states that are set to one said context, during the operating cycles in which the operating states do not occur.

In the third invention, a multiplicity of processor elements are divided into (a×b) element areas; each of a number (a) of respective state control units is connected to a respective group of (b) element areas of these (a×b) element areas; and the connected state control units temporarily halt operations of the element areas that correspond to a prescribed number of operating states that are set to one context during operating cycles in which operating states do not occur.

In the array-type processor of the present invention, the state control units temporarily halt individual operations of the above-described plurality of element areas as described above to thus allow selective operation of element areas in accordance with a plurality of operating states that are set to a single context, whereby the array-type processor can be operated more effectively.

In the present invention, plurality indicates any integer equal to or greater than 2, and multiplicity indicates any integer equal to or greater than the above-described plurality.

The above and other objects, features, and advantages of the present invention will become apparent from the following description with reference to the accompanying drawings, which illustrate examples of the present invention.

### BRIEF DESCRIPTION OF THE DRAWINGS

FIGS. 1A and 1B are schematic views of the correlation between operating states and contexts resulting from the numbers of assigned processor elements;

FIG. 2 is a schematic view showing the assignment of a plurality of continuous operating states to one context;

FIG. 3 is a schematic view showing the correlation between operating states and contexts resulting from the numbers of assigned processor elements;

FIG. 4 is a schematic view showing the assignment of a plurality of discontinuous operating states to one context;

FIG. 5 is a schematic block diagram showing the physical construction of an array-type processor of an embodiment of the present invention;

FIGS. 6A and 6B is a block diagram showing the physical configuration of mb-buses and nb-buses of the array-type processor;

FIG. 7 is a block diagram showing the physical configuration of the command buses; and

FIG. 8 shows an example of a modification of the embodiment of the present invention.

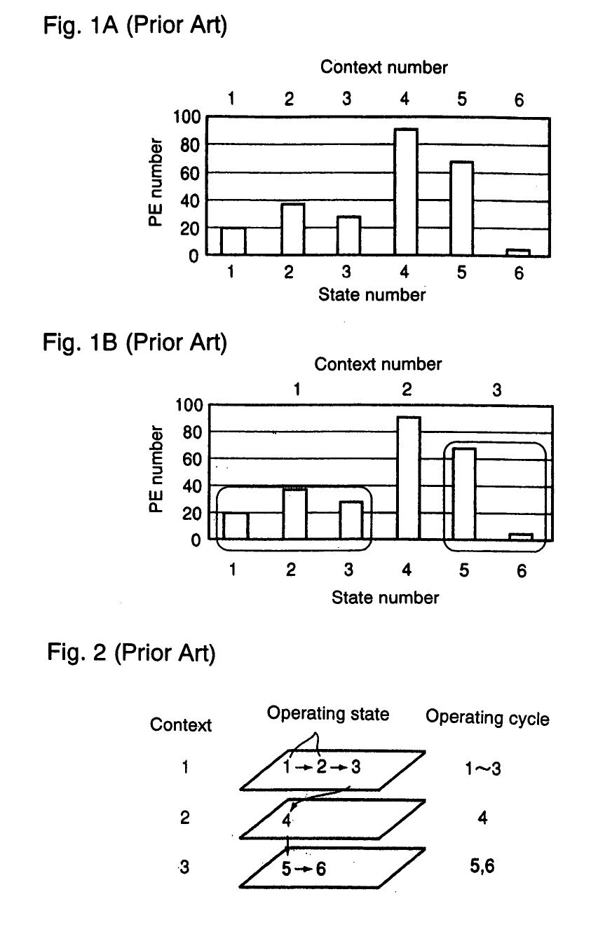

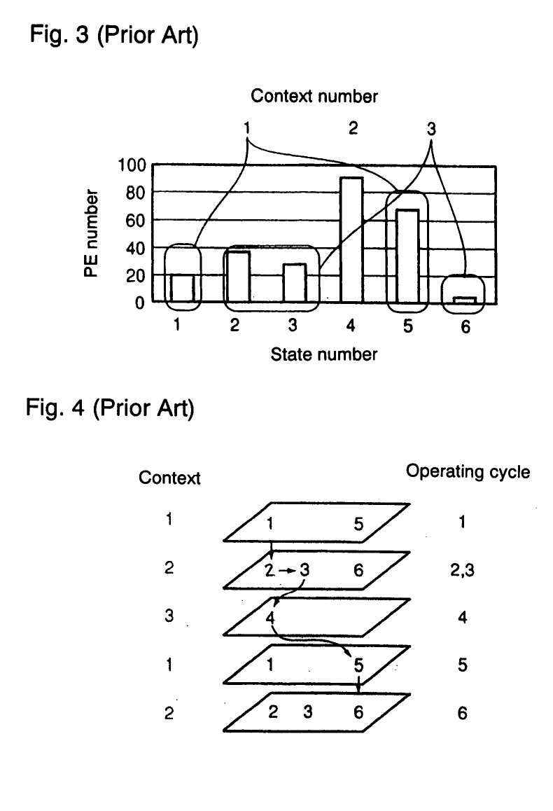

### DETAILED DESCRIPTION OF THE PREFERRED EMBODIMENTS

Construction of an Embodiment

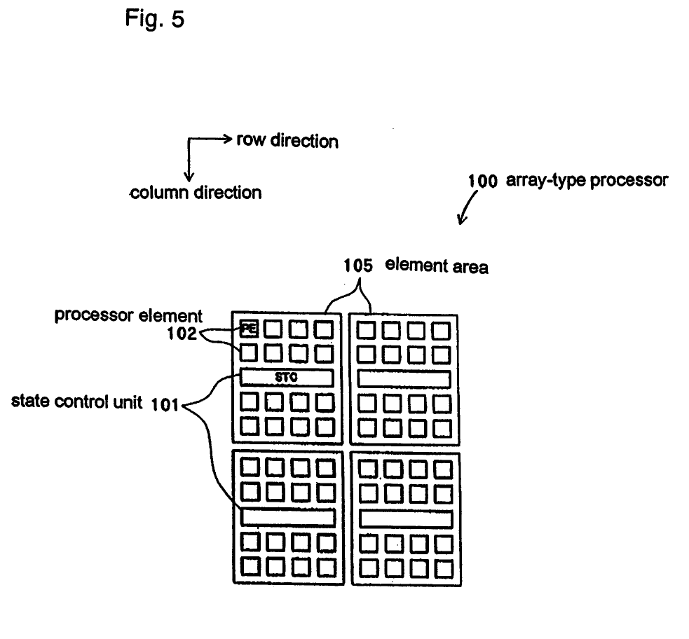

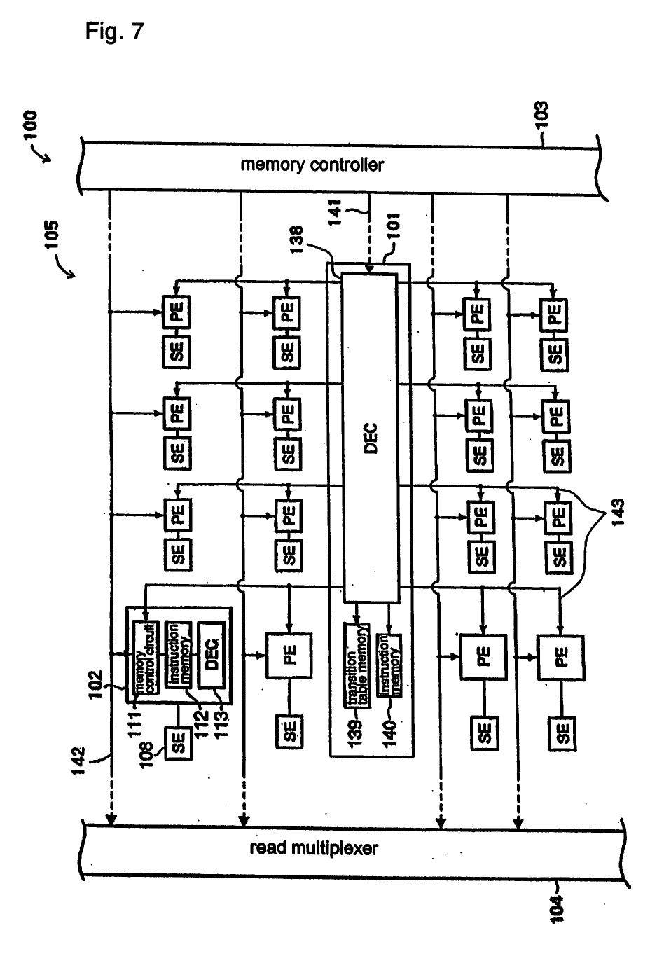

An embodiment of the present invention is next described with reference to FIGS. 5 to 7. First, as shown in FIG. 7, array-type processor 100 of the present embodiment includes as its chief constituent elements: state control unit 101, processor elements 102, memory controller 103, and read multiplexer104.

Further, as shown in FIG. 5, state control unit 101 in array-type processor 100 of the present embodiment is actually composed of a plurality of units that communicate with each other and thus operate in concert, and the multiplicity of processor elements 102 are divided into element areas 105 that correspond in number to the number of state control units 101.

The plurality of state control units 101 is connected to groups of processor elements 102, these groups being defined by the plurality of element areas 105, and each state control unit 101 is arranged in a respective element area 105 of processor elements 102 to which that state control unit 101 is connected.

To state in greater detail, the multiplicity of processor elements 102 are arranged in rows and columns for each of the plurality of element areas 105; and the plurality of element areas 105 that are each divided into rectangles are in turn arranged in rows and columns. Finally, each state control unit 101 is formed in a shape that is equivalent to one row of processor elements 102 in element areas 105, and state control units 101 are each arranged in substantially the center in the column direction of respective element areas 105.

In the interest of simplifying the following explanation, in array-type processor 100 of the present embodiment, four element areas 105-1105-4 are arranged in two rows and two columns as shown in the figures, and 16 processor elements 102 are arranged in four rows and four columns in each of element areas 105.

In addition, the right/left directions in FIG. 5 correspond to the row direction and the up/down directions correspond to the column direction, the rows each being arranged in the column direction and the columns each being arranged in the row direction. State control units 101 are thus formed in a shape equivalent to one row of four processor elements 102 in each of element areas 105 and are each arranged between the second and third rows of processor elements 102 in each of element areas 105.

As shown in FIG. 7, memory controller 103 transmits various types of data that have been received as input from the outside to state control unit 101 and to processor elements 102 of element area 105, and read multiplexer 104 supplies various types of data that have been read from processor elements 102 to the outside.

Processor elements 102 execute data processing using the various types of data that have been received as input from memory controller 103, and supply the various data that have undergone data processing to read multiplexer 104 as output. State control unit 101 controls the state transitions of processor elements 102 of this element area 105 and thus causes processor elements 102 of this element area 105 to execute various types of data processing.

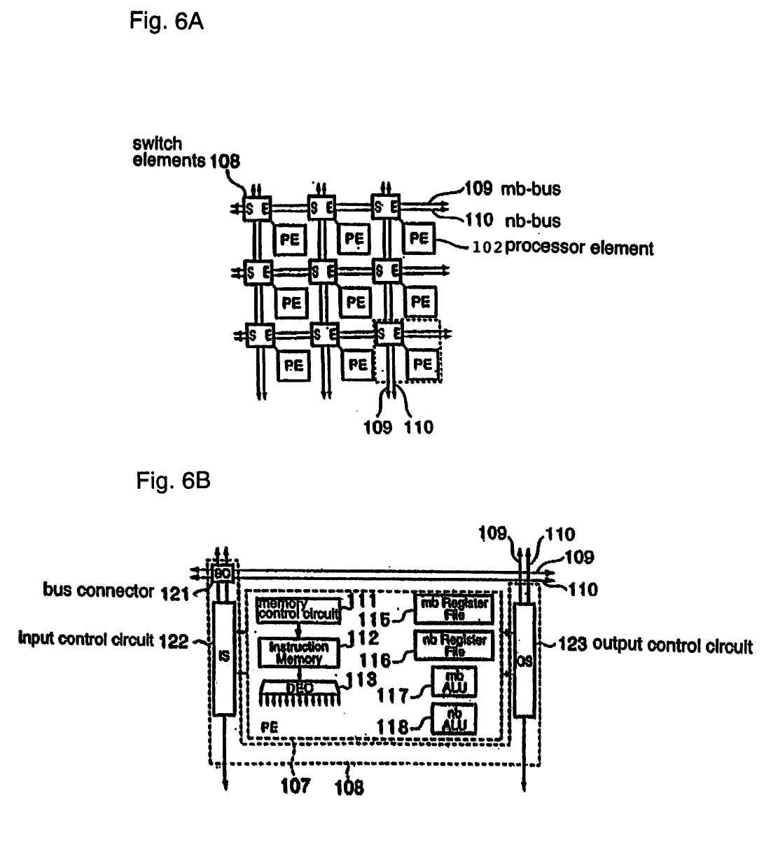

More specifically, as shown in FIGS. 6A, 6B and 7, a multiplicity of switch elements 108 are arranged in rows and columns together with the multiplicity of processor elements 102 in element area 105, and the multiplicity of processor elements 102 are connected in matrix form by a multiplicity of mb (m-bit) buses 109 and a multiplicity of nb (n-bit) buses 110 by way of these switch elements 108.

In addition, as shown in FIG. 6B, processor elements 102 include such components as: memory control circuit 111, instruction memory 112, instruction decoder 113, mb-register file 115, nb-register file 116, mb-ALU (Arithmetic and Logical Unit) 117, nb-ALU 118, and internal variable interconnects (not shown in the figure); and switch elements 108 each include: bus connector 121, input control circuit 122, and output control circuit 123.

As shown in FIG. 7, the plurality of state control units 101 each include, for example: instruction decoder 138, transition table memory 139, and instruction memory 140; and are connected to memory controller 103 by instruction buses 141.

In addition, eight rows of instruction buses 142 are connected in parallel from memory controller 103 to read multiplexer 104, and each of these eight rows of instruction busses 142 is connected to memory control circuits 111 of eight columns of processor elements 102.

The single instruction decoder 138 of each state control unit 101 is connected to two sets of four columns of address buses 143, and each column of these address buses 143 is connected to memory control circuits 111 of two rows of processor elements 102.

Instruction buses 141 are formed with a bus width of, for example, 20 (bits), instruction buses 142 and address buses 143 are formed with a bus width of, for example, 8 (bits), and memory controller 103 is connected to four state control units 101 by instruction buses 141.

However, because state control units 101 are connected to processor elements 102 by element area 105 in array-type processor 100 of the present embodiment as described hereinabove, each of state control units 101 implements state control over only those processor elements 102 to which that state control unit 101 is connected.

In the computer program that is supplied from the outside in array-type processor 100 of the present embodiment, moreover, the instruction codes of the multiplicity of processor elements 102 and the multiplicity of switch elements 108 of element areas 105 are data that are set as contexts that successively switch, and the instruction codes of state control units 101 that switch these contexts with each operating cycle are data that are set as operating states that undergo successive transitions.

Thus, as shown in FIG. 7, in each state control unit 101, the instruction codes for that state control unit 101 are stored as data in instruction memory 140, and the transition rules for causing the successive transitions of a plurality of operating states are stored as data in transition table memory 139.

State control units 101 cause successive transitions of operating states in accordance with the transition rules of transition table memory 139 and generate instruction pointers of processor elements 102 and switch elements 108 by means of the instruction codes of instruction memory 140.

As shown in FIG. 6B, switch element 108 shares instruction memories 112 of adjacent processor elements 102, and state control unit 101 therefore supplies the instruction pointers of processor elements 102 and switch elements 108 that have been generated to instruction memories 112 of corresponding processor elements 102.

Since the plurality of instruction codes of processor elements 102 and switch elements 108 are stored as data in these instruction memories 112, a single instruction pointer that is supplied from state control unit 101 designates the instruction codes of processor elements 102 and switch elements 108. Instruction decoder 113 decodes the instruction codes that have been designated by an instruction pointer and controls the operation of, for example, switch element 108, internal variable interconnects, mb-ALU 117, and nb-ALU 118. Mb-buses 109 transmit processing data of mb (i.e., 8 bits), nb-buses 110 transmit processing data of nb (i.e., 1 bit), and switch elements 108 therefore control the connection relations of the multiplicity of processor elements 102 by mb-buses 109 and nb-buses 110 in accordance with the operation control of instruction decoder 113.

To state in greater detail, bus connectors 121 of switch elements 108 link mb-buses 109 and nb-buses 110 in four directions and control the connection relations of the plurality of linked mb-buses 109 and the connections relations of the plurality of linked nb-buses 110.

As a result, in array-type processor 100, for each of the plurality of element areas 105, state control units 101 successively switch the contexts of processor elements 102 for each operating cycle in accordance with the computer program that is supplied from the outside, and for each of these stages, the plurality of processor elements 102 operate simultaneously on data processing that can be freely and individually set.

As shown in FIG. 6B, input control circuit 122 controls both the connection relations of data input from mb-buses 109 to mb-register file 115 and mb-ALU 117 and the connection relations of data input from nb-buses 110 to nb-register file 116 and nb-ALU 118.

Output control circuit 123 controls the connection relations of both the data output from mb-register file 115 and mb-ALU 117 to mb-buses 109 and the connection relations of the data output from nb-register file 116 and nb-ALU 118 to nb-buses 110.

The internal variable interconnects of processor element 102 control both the connection relations of mb-register file 115 and mb-ALU 117 and the connection relations of nb-register file 116 and nb-ALU 118 inside processor element 102 under the operation control of instruction decoder 113.

Mb-register file 115 temporarily holds processing data of m bits that are received as input from, for example, mb-buses 109 in accordance with the connection relations that are controlled by the internal variable interconnects and supplies these data to, for example, mb-ALU 117. Nb-register file 116 temporarily holds data of n bits that are received as input from, for example, nb-buses 110 in accordance with the connection relations that are controlled by the internal variable interconnects and supplies these data as output to, for example, nb-ALU 118.

Mb-ALU 117 executes data processing using the processor data of m bits under the operation control of instruction decoder 113, and nb-ALU 118 executes data processing using the processing data of n bits under the operation control of instruction decoder 113, whereby data processing of m bits and n bits is executed as appropriate in accordance with the number of bits of the processing data.

The results of this processing by processor elements 102 for each element area 105 are fed back as necessary as event data to state control units 101, whereby these state control units 101, by means of these event data that have been received as input, both cause the transitions of operating states to the next operating state and switch the contexts of processor elements 102 to the next stage of context.

In array-type processor 100 of the present embodiment, however, a prescribed number of operating states that occur in different operating cycles are set to at least a portion of the contexts, and state control units 101 that correspond to a prescribed number of operating states that are set to one of these contexts temporarily halts the operation of element area 105 to which that state control unit 101 is connected during operating cycles in which operating states do not occur.

Operation of an Embodiment

In array-type processor 100 of the present embodiment of the construction described in the foregoing explanation, when executing data processing in accordance with a computer program that is supplied from the outside using processing data that have been received as input from the outside, state control units 101 for each of the plurality of element areas 105 both cause successive transitions of the operating states and successively switch the contexts of processor elements 102 with each operating cycle. Thus, for each of these operating cycles, the multiplicity of processor elements 102 operate simultaneously on data processing that can be freely and individually set, and the multiplicity of switch elements 108 switch-control the connection relations of the multiplicity of processor elements 102.

In array-type processor 100 of the present embodiment, however, a prescribed number of operating states that occur in different operating cycles are set to at least a portion of the contexts that undergo successive transitions as described above, and state control unit 101 that corresponds to a prescribed number of operating states that are set to one of these contexts temporarily halts the operation of element area 105 to which it is connected during operating cycles in which operating states do not occur.

Effects of the Embodiment

Array-type processor 100 of the present embodiment allows the absolute maximum number of processor elements to be set for a plurality of contexts, as described in the example of the prior art, whereby the number of contexts can be reduced and the data volume of a computer program can be decreased. Further, the reduced number of instances of switching of the contexts of the data path unit also enables a reduction of the power consumption.

Thus, in array-type processor 100 of the present embodiment, a plurality of state control units 101 temporarily halt each of a plurality of element areas 105 as described hereinabove, whereby operations corresponding to a plurality of operating states that are set for a single context can be implemented more effectively.

The array-type processor that was disclosed in Japanese Patent Laid-Open Publication No. 312481 (2001) that was submitted by the present applicant also has the function by which state control units 101 temporarily halt the operations of processor elements 102 to which state control units 101 are connected. In other words, operations in a plurality of element areas 105 can each be temporarily halted in array-type processor 100 of the present embodiment by applying a function that was known from the prior art in a plurality of state control units 101, and operation that corresponds to a plurality of operating states that are set to a single context can therefore be easily implemented.

A Modification of the Embodiment

The present invention is not limited to the above-described embodiment and is open to various modifications within the scope of the invention. For example, although the number of element areas 105 and processor elements 102 or the numerical values of the arrangement were described in specific terms in the above-described embodiment, these numerical values may of course be variously set.

In addition, although a case was presented in the above-described embodiment in which each of a plurality of element areas 105 was connected to a respective state control unit 101 of an equal number of state control units 101, it is also possible for a single state control unit 101 to be connected to a plurality of element areas 105, and for state control unit 101 to temporarily halt the operation of element areas 105 that correspond to a prescribed number of operating states that are set to a single context during operating cycles in which operating states do not occur.

In such a case, one state control unit 101 temporarily halts the operation of individual element areas 105 of a plurality of element areas 105 and thus can realize operations that correspond to a plurality of operating states that are set to a single context. Further, providing a plurality of state control units 101 that can individually control the operations of a plurality of element areas 105 enables the individual control over the operations of even more numerous element areas 105 by a plurality of state control units 101.

In addition, although a case was presented in the above-described embodiment in which state control units 101 selectively cause temporary halting of [the operations of] a plurality of element areas 105 that correspond to a plurality of operating states of contexts, when a portion of the plurality of element areas 105 are all temporarily halted, it can be anticipated that obstacles will occur, for example, in the sharing of data between the plurality of element areas 105.

When such obstacles present a problem, it is possible for state control unit 101 to cause the operation of a portion of the plurality of processor elements 102 of element areas 105 that are temporarily halted, whereby problems will not occur despite the temporary halt of the operations of a portion of a plurality of element areas 105 that share data.

As proposed by the present applicant in Japanese Patent Application No. 299029 (2002), in a case in which a shared resource that is shared by a plurality of element areas 105 is installed in array-type processor 100 (not shown in the figure), when a plurality of element areas 105 share a shared resource by means of a plurality of operating states of the same context, element areas 105 that are temporarily halted are unable to switch the path to the shared resource.

When this inability poses a problem in such a case, it is possible for state control unit 101 to switch the paths from the plurality of element areas 105 to the shared resource such that no problems occur even when a portion of the plurality of element areas 105 that share the shared resource are temporarily halted.

Further, a case was described in the above-described array-type processor 100 in which processor elements 102 that each include mb-register file 115, nb-register file 116, mb-ALU 117, and nb-ALU 118 are connected by mb-buses 109 and nb-buses 110, and in which processor elements 102 execute data processing and data communication in m-bits and n-bits.

However, it is also possible for data processing and data communication to be executed in three or more types of bit numbers by hardware of three or more types of bit numbers, or for data processing and data communication to be executed in one type of bit number by hardware of one type of bit number.

Still further, a case was described in array-type processor 100 of the above-described embodiment in which instruction memory 112 was shared by adjacent processor elements 102 and switch element 108, and in which the instruction codes of processor elements 102 and switch element 108 were generated by a single instruction pointer.

However, it is possible for instruction memories to be separately provided for the exclusive use of processor elements 102 and switch element 108, and for the instruction codes for processor elements 102 and switch element 108 to each be separately generated by distinct instruction pointers.

Still further, in the interest of simplifying the explanation and figures in the above-described embodiment, a case was presented in which one mb-bus 109 and one nb-bus 110 were connected for each row and column direction for each of processor elements 102. However, it is actually ideal for a plurality of mb-buses 109 and nb-buses 110 to be connected for each of processor elements 102.

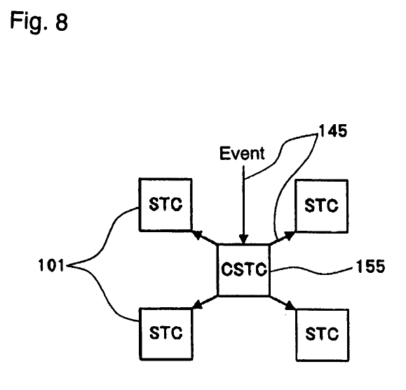

Finally, although a case was described in array-type processor 100 of the above-described embodiment in which a plurality of state control units 101 intercommunicate on the same level to realize linked operation, it is also possible for, for example, one of the plurality of state control units 101 to be set as a higher-order master and the others to be set as lower-order slaves, or, as shown in FIG. 8, for dedicated central control unit 155 to be provided at a higher level than the plurality of state control units 101.

Ideally, in such a case, all of the plurality of event data that are supplied as output by processor elements 102 and state control units 101 are supplied as input to central control unit 155, and this central control unit 155 then distributes event data to the plurality of state control units 101. However, when state control units 101 are numerous as previously described, the delay that occurs in the transmission of event data from a single central control unit 155 to remote state control units 101 becomes problematic.

While a preferred embodiment of the present invention has been described using specific terms, such description is for illustrative purposes only, and it is to be understood that changes and variations may be made without departing from the spirit or scope of the following claims.

What is claimed is:

1. An array-type processor in which a multiplicity of processor elements, which individually execute data processing in accordance with instruction codes in which data are individually set, are arranged in rows and columns, and a state control unit causes successive transitions of operating states of the multiplicity of processor elements for each operating cycle by means of contexts that are composed of said instruction codes; wherein:
said multiplicity of processor elements are divided into a plurality of element areas;
one said state control unit is connected to the plurality of element areas;
a prescribed number of said operating states that occur in different said operating cycles are set to at least a portion of said contexts; and
said state control unit temporarily halts operations of said element areas that correspond to a prescribed number of said operating states that are set to one said context during said operating cycles in which said operating states do not occur.

2. An array-type processor in which a multiplicity of processor elements, which individually execute data processing in accordance with instruction codes in which data are individually set, are arranged in rows and columns, and state control units cause successive transitions of operating states of the multiplicity of processor elements for each operating cycle by means of contexts that are composed of said instruction codes; wherein:
said multiplicity of processor elements are divided into a plurality of element areas;
each of the plurality of element areas is connected to a respective state control unit of an equal number of the element areas;
a prescribed number of said operating states that occur in different said operating cycles are set to at least a portion of said contexts; and
said state control units temporarily halt operations of said element areas to which said state control units are connected, the operations of the element areas corresponding to a prescribed number of said operating states that are set to one said context, during said operating cycles in which said operating states do not occur.

3. An array-type processor in which a multiplicity of processor elements, which individually execute data processing in accordance with instruction codes in which data are individually set, are arranged in rows and columns, and state control units cause successive transitions of operating states of the multiplicity of processor elements for each operating cycle by means of contexts that are composed of said instruction codes; wherein:
said multiplicity of processor elements are divided into a number (a×b) of element areas;
each of a number (a) of said state control units is connected to a respective group of (b) element areas of these (ax b) element areas;
a prescribed number of said operating states that occur in different said operating cycles are set to at least a portion of said contexts;
said state control units temporarily halt operations of said element areas to which said state control units are connected, the operations of the element areas corresponding to a prescribed number of said operating states that are set to one said context, during said operating cycles in which said operating states do not occur.

4. An array-type processor according to claim 1, wherein said state control units cause an operation of a portion of a plurality of processor elements of said element areas that said state control units have temporarily halted.

5. An array-type processor according to claim 2, wherein said state control units cause an operation of a portion of a plurality of processor elements of said element areas that said state control units have temporarily halted.

6. An array-type processor according to claim 3, wherein said state control units cause an operation of a portion of a plurality of processor elements of said element areas that said state control units have temporarily halted.

7. An array-type processor according to claim 1, wherein:
a shared resource is provided that is shared by said plurality of element areas; and
said state control units switch paths to said shared resource from said plurality of element areas.

8. An array-type processor according to claim 2, wherein:
a shared resource is provided that is shared by said plurality of element areas; and
said state control units switch paths to said shared resource from said plurality of element areas.

9. An array-type processor according to claim 3, wherein:
a shared resource is provided that is shared by said plurality of element areas; and
said state control units switch paths to said shared resource from said plurality of element areas.

10. An array-type processor according to claim 4, wherein:
a shared resource is provided that is shared by said plurality of element areas; and
said state control units switch paths to said shared resource from said plurality of element areas.

11. An array-type processor according to claim 5, wherein:
a shared resource is provided that is shared by said plurality of element areas; and
said state control units switch paths to said shared resource from said plurality of element areas.

12. An array-type processor according to claim 6, wherein:
a shared resource is provided that is shared by said plurality of element areas; and
said state control units switch paths to said shared resource from said plurality of element areas.
